(19) United States
(12) Patent Application Publication
(10) Pub. No.: US 2026/0074470 A1
(43) Pub. Date: Mar. 12, 2026

(54) TEMPERATURE DETECTOR, CONNECTOR, CONNECTOR ASSEMBLY AND ELECTRICAL CONNECTION SYSTEM

(71) Applicants: TE Connectivity Solutions GmbH, Schaffhausen (CH); Tyco Electronics (Shanghai) Co., Ltd., Shanghai (CN)

(72) Inventors: Qianjin (Orando) Li, Shanghai (CN); Peter Goesseringer, Fremont, CA (US); Cristian S. Regus, Fremont, CA (US)

(73) Assignees: TE Connectivity Solutions GmbH, Schaffhausen (CH); Tyco Electronics (Shanghai) Co., Ltd., Shanghai (CN)

(21) Appl. No.: 19/320,195

(22) Filed: Sep. 5, 2025

(30) Foreign Application Priority Data
Sep. 6, 2024 (CN) 202411253653.0

(51) Int. Cl. H01R 13/66

(52) U.S. Cl. CPC H01R 13/6683

(57) ABSTRACT

A temperature detector for detecting a temperature of a terminal of a connector includes a heat conducting member including a cylindrical portion and a connecting tab connected to the cylindrical portion, and a temperature sensor inserted into the cylindrical portion of the heat conducting member. The connecting tab has a through hole receiving a bolt that fastens the heat conducting member to the terminal to create thermal contact between the heat conducting member and the terminal. The temperature sensor is in thermal contact with an inner peripheral wall of the cylindrical portion of the heat conducting member or is thermally connected to the inner peripheral wall of the cylindrical portion of the heat conducting member by a thermally conductive adhesive.

### CROSS-REFERENCE TO RELATED APPLICATION

This application claims the benefit of the filing date under 35 U.S.C. § 119(a)-(d) of Chinese Patent Application No. 202411253653.0, filed on Sep. 6, 2024.

### FIELD OF THE INVENTION

The present invention relates to a temperature detector, a connector including the temperature detector, a connector assembly including the connector, and an electrical connection system including the connector.

### BACKGROUND OF THE INVENTION

Terminals of a connector heat up during operation. A temperature detection device is typically installed in the connector to prevent the terminals from overheating. However, the existing temperature detection device has a complex structure and is difficult to install and large in size, which is not conducive to the miniaturization of the connector.

### SUMMARY OF THE INVENTION

A temperature detector for detecting a temperature of a terminal of a connector includes a heat conducting member including a cylindrical portion and a connecting tab connected to the cylindrical portion, and a temperature sensor inserted into the cylindrical portion of the heat conducting member. The connecting tab has a through hole receiving a bolt that fastens the heat conducting member to the terminal to create thermal contact between the heat conducting member and the terminal. The temperature sensor is in thermal contact with an inner peripheral wall of the cylindrical portion of the heat conducting member or is thermally connected to the inner peripheral wall of the cylindrical portion of the heat conducting member by a thermally conductive adhesive.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows an illustrative exploded view of a connector according to an exemplary embodiment of the present invention;

FIG. 3 shows an illustrative perspective view of two terminal assemblies of a connector according to an exemplary embodiment of the present invention;

FIG. 4 shows an illustrative perspective view of one terminal assembly of a connector according to an exemplary embodiment of the present invention, as viewed from the outside;

FIG. 5 shows an illustrative perspective view of one terminal assembly of a connector according to an exemplary embodiment of the present invention, as viewed from the inside;

FIG. 6 shows a longitudinal sectional view of one terminal assembly of a connector according to an exemplary embodiment of the present invention;

FIG. 7 shows an illustrative exploded view of one terminal assembly of a connector according to an exemplary embodiment of the present invention;

FIG. 8 shows an illustrative perspective view of a temperature detector according to an exemplary embodiment of the present invention; and

FIG. 9 shows an illustrative exploded view of a temperature detector according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

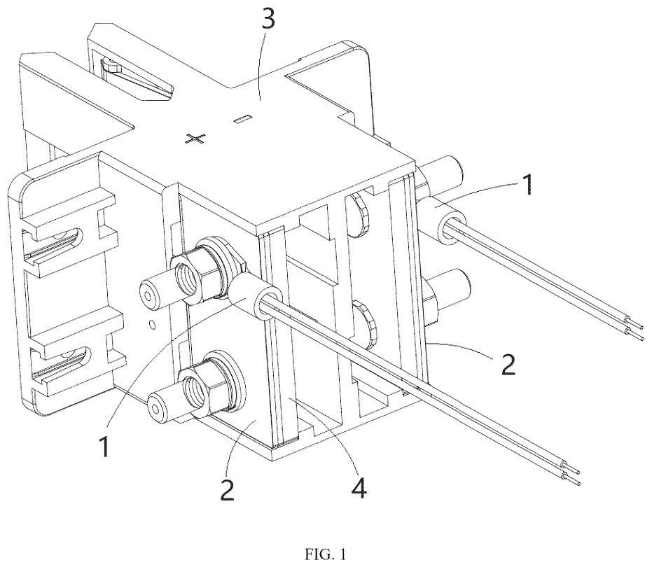

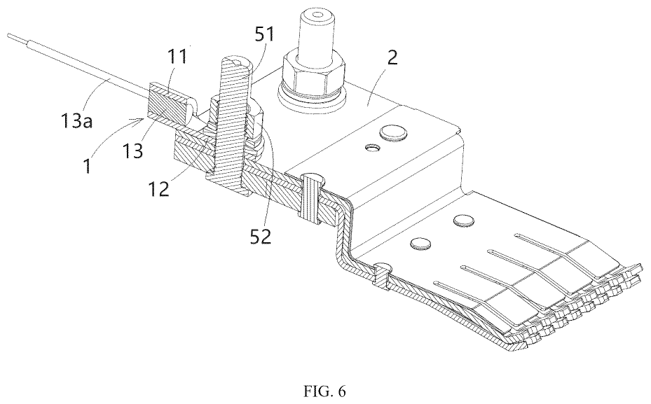

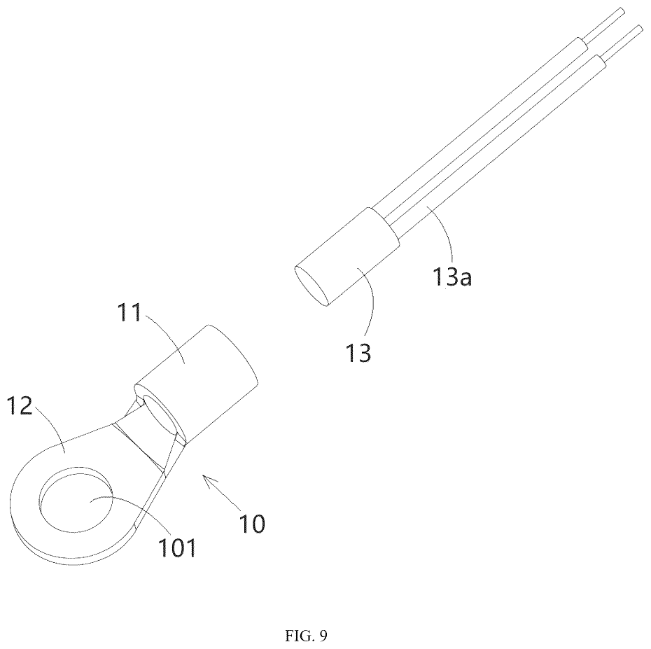

As shown in FIGS. 1 to 9, in an exemplary embodiment of the present invention, a temperature detector is disclosed. The temperature detector is configured for detecting a temperature of a terminal 2 of a connector. The temperature detector 1 includes a heat conducting member 10 and a temperature sensor 13. The heat conducting member 10 includes a cylindrical portion 11 and a connecting tab 12 connected to the cylindrical portion 11. The temperature sensor 13 is inserted into the cylindrical portion 11 of the heat conducting member 10. The temperature sensor 13 is in thermal contact with an inner peripheral wall of the cylindrical portion 11 of the heat conducting member 10 or is thermally connected to the inner peripheral wall of the cylindrical portion 11 of the heat conducting member 10 by a thermally conductive adhesive. A through hole 101 allowing a bolt 51 to pass through is formed on the connecting tab 12 of the heat conducting member 10 to enable the connecting tab 12 of the heat conducting member 10 to be fastened to the terminal 2 by the bolt 51, so as to be in thermal contact with the terminal 2.

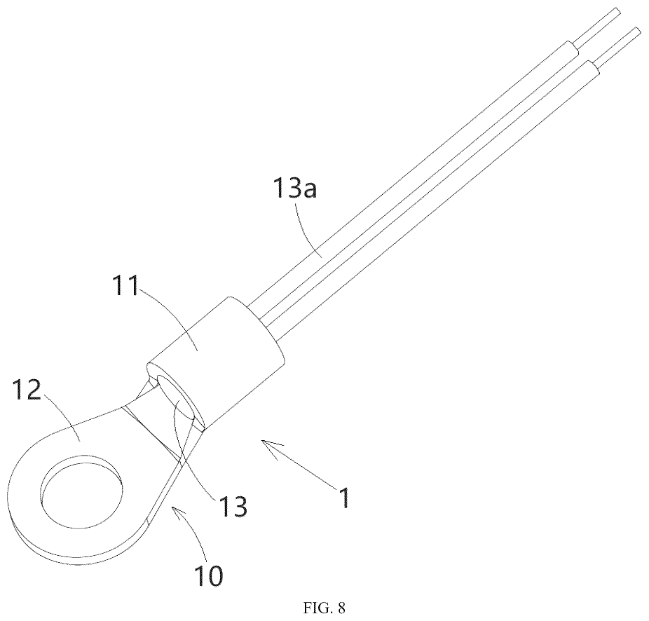

As shown in FIG. 8, in the illustrated embodiment, the cylindrical portion 11 of the heat conducting member 10 has two ends opposite each other in an axial direction thereof, the connecting tab 12 is connected to one end of the cylindrical portion 11, and a lead wire 13a of the temperature sensor 13 is led out from the other end of the cylindrical portion 11.

In the illustrated embodiment, the heat conducting member 10 is an integral stamped metal part. For example, the heat conducting member 10 may be a copper component or an aluminum component. In the illustrated embodiment, the connecting tab 12 of the heat conducting member 10 has a flat contact surface adapted to abut against a surface of one side of the terminal 2. In the illustrated embodiment, the temperature sensor 13 may be an NTC (negative temperature coefficient thermistor) temperature sensor.

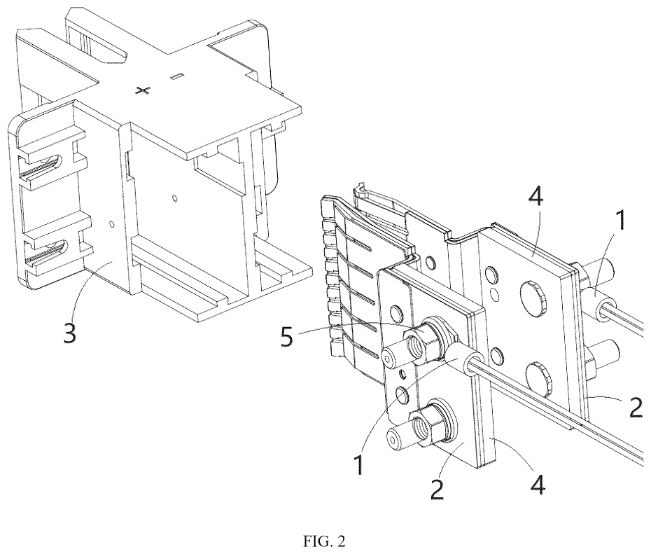

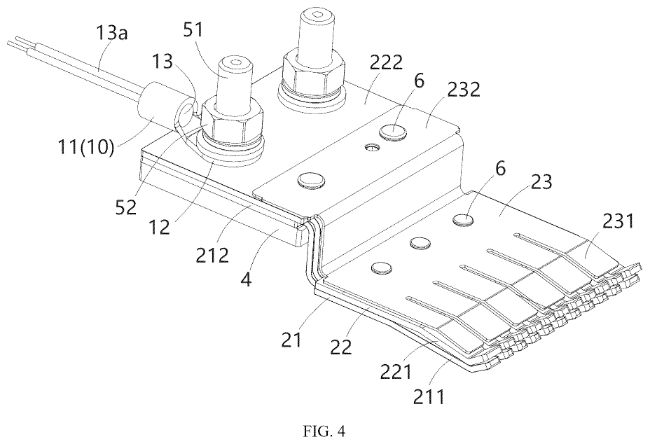

As shown in FIGS. 1 and 2, in another exemplary embodiment of the present invention, a connector is also disclosed. The connector includes a housing 3, a pair of terminals 2, and at least two temperature detectors 1. The pair of terminals 2 are inserted in the housing 3 and have inner sides facing each other and outer sides facing away from each other. Connecting tabs 12 of the at least two temperature detectors 1 are fastened to the outer sides of the pair of terminals 2 respectively, as shown in FIGS. 4-6. The at least two temperature sensors 13 are configured to detect the temperature of the pair of terminals 2, respectively.

As shown in FIGS. 2-7, in the illustrated embodiment, the connector further includes at least two fastening assemblies 5 configured to fasten two cable connecting plates 4 to the inner sides of the pair of terminals 2, respectively. The at least two fastening assemblies 5 are further configured to fasten the connecting tabs 12 of the at least two temperature sensors 13 to the outer sides of the pair of terminals 2, respectively.

In the illustrated embodiment, as shown in FIGS. 1-7, the connector includes four temperature detectors 1 and four fastening assemblies 5 configured to fasten the four temperature detectors 1 respectively, and two temperature detectors 1 are fastened on the outer side of each terminal 2.

In the illustrated embodiment, the connector further includes two cables and two cable connecting plates 4. The two cables are electrically connected to the two cable connecting plates 4, respectively, shown in FIGS. 1-3. The two cable connecting plates 4 are fastened to the inner sides of the pair of terminals 2 by the at least two fastening assemblies 5, respectively.

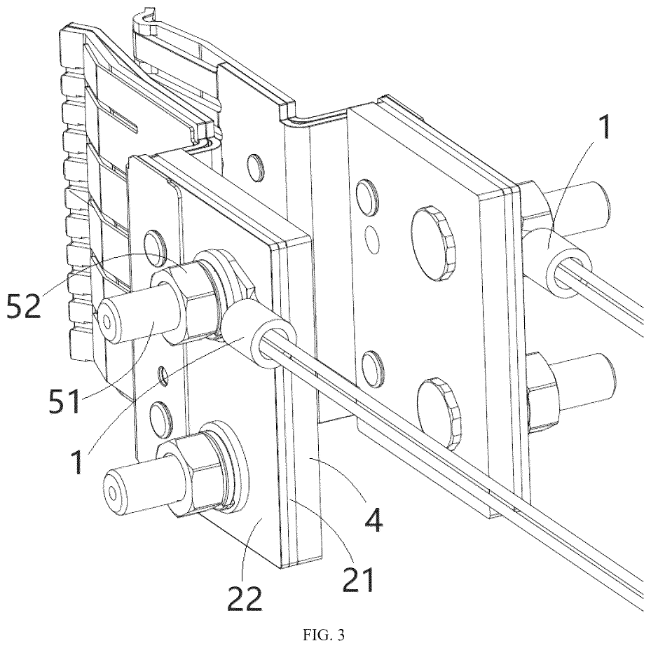

As shown in FIGS. 3-7, in the illustrated embodiment, the fastening assembly 5 includes a nut and a bolt 51, and the bolt 51 passes through the cable connecting plate 4, the terminal 2 and the connecting tab 12 and is in threaded connection with the nut to simultaneously fasten the cable connecting plate 4 and the connecting tab 12 to the terminal 2.

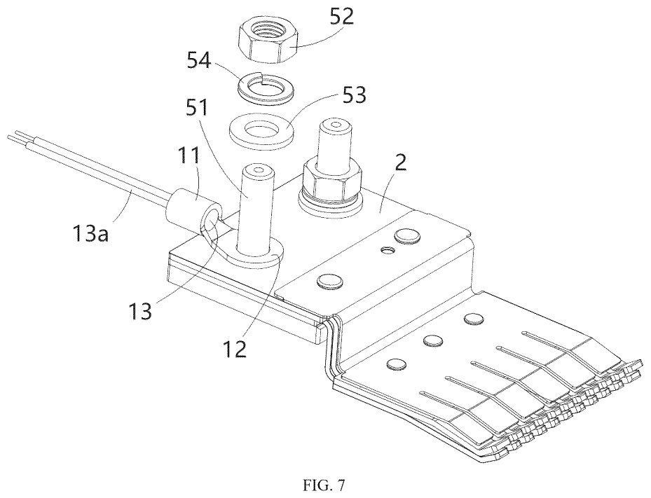

As shown in FIG. 7, in the illustrated embodiment, the fastening assembly 5 further includes a rigid washer 53 and an elastic washer 54, the bolt 51 passes through the rigid washer 53 and the elastic washer 54, and the rigid washer 53 and the elastic washer 54 are disposed between the nut and the connecting tab 12 to ensure a reliable thermal contact between the connecting tab 12 and the terminal 2 and to prevent loosening of the connecting tab 12. In the illustrated embodiment, the rigid washer 53 is compressed between the connecting tab 12 and the elastic washer 54, and the elastic washer 54 is compressed between the rigid washer 53 and the nut.

As shown in FIGS. 3-5, in the illustrated embodiment, the terminal 2 includes a first terminal plate 21 and a second terminal plate 22. The first terminal plate 21 has a row of first elastic arms 211 at a front end thereof and a first connecting plate 212 at a rear end thereof. The second terminal plate 22 is stacked on an outer side of the first terminal plate 21, the second terminal plate 22 has a row of second elastic arms 221 at a front end thereof and a second connecting plate 222 at a rear end thereof. The row of second elastic arms 221 abuts against an outer side of the row of first elastic arms 211, the first elastic arms 211 and the second elastic arms 221 are configured to be simultaneously in electrical contact with one side of a mating plug inserted between front ends of the pair of terminals 2. The second connecting plate 222 abuts against an outer side of the first connecting plate 212, and the connecting tab 12 of the heat conducting member 10 abuts against an outer side of the second connecting plate 222 to be in thermal contact with the outer side of the second connecting plate 222.

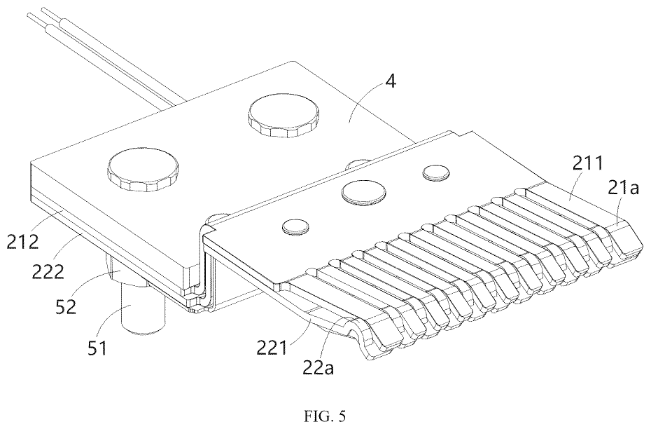

As shown in FIG. 5, in the illustrated embodiment, a first contact 21a is formed at a tail end of each of the first elastic arms 211, and a second contact 22a is formed at a tail end of each of the second elastic arms 221, the first contacts 21a and the second contacts 22a are arranged in a row alternatively, and are configured to be simultaneously in electrical contact with one side of the mating plug inserted between the front ends of the pair of terminals 2.

As shown in FIG. 4, in the illustrated embodiment, the terminal 2 further includes an auxiliary elastic piece 23 stacked on an outer side of the second terminal plate 22 and having a row of auxiliary elastic arms 231 at a front end thereof and an auxiliary connecting plate 232 at a rear end thereof. The auxiliary connecting plate 232 abuts against the outer side of the second connecting plate 222, and the first terminal plate 21, the second terminal plate 22 and the auxiliary elastic piece 23 are riveted together by a riveting pin 6 passing therethrough.

In another exemplary embodiment of the present invention, a connector assembly is also disclosed. The connector assembly includes a connector and a mating connector mating with the connector. The mating connector includes a mating plug inserted between a pair of terminals 2 of the connector and in electrical contact with the pair of terminals 2.

In another exemplary embodiment of the present invention, an electrical connection system is also disclosed. The electrical connection system includes: a load circuit, a connector, and a control circuit. A pair of terminals 2 of the connector are electrically connected to the load circuit. The control circuit is connected to a temperature detector 1 of the connector and is configured to control the power on and power off of the load circuit based on the temperature of the terminals 2 detected by the temperature detector 1. The control circuit cuts off the power supply of the load circuit when the temperature of the terminals 2 detected by the temperature detector 1 exceeds a predetermined temperature. In this way, various accidents caused by high terminal temperatures are avoided.

In the aforementioned various exemplary embodiments according to the present invention, the temperature detector has a simple structure and is easy to install and small in size, which enables the miniaturization of the connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “including” an element or a plurality of elements having a particular property may include additional such elements not having that property.

1. A temperature detector for detecting a temperature of a terminal of a connector, comprising:
a heat conducting member including a cylindrical portion and a connecting tab connected to the cylindrical portion, the connecting tab has a through hole receiving a bolt that fastens the heat conducting member to the terminal to create thermal contact between the heat conducting member and the terminal; and
a temperature sensor inserted into the cylindrical portion of the heat conducting member, the temperature sensor is in thermal contact with an inner peripheral wall of the cylindrical portion of the heat conducting member or is thermally connected to the inner peripheral wall of the cylindrical portion of the heat conducting member by a thermally conductive adhesive.

2. The temperature detector according to claim 1, wherein the cylindrical portion of the heat conducting member has a pair of ends opposite each other in an axial direction, the connecting tab is connected to one end of the cylindrical portion, and a lead wire of the temperature sensor is led out from the other end of the cylindrical portion.

3. The temperature detector according to claim 1, wherein the heat conducting member is an integral stamped metal part.

4. The temperature detector according to claim 1, wherein the connecting tab of the heat conducting member has a flat contact surface adapted to abut against a surface of one side of the terminal.

5. The temperature detector according to claim 1, wherein the temperature sensor is an NTC temperature sensor.

6. A connector, comprising:
a housing;
a pair of terminals inserted in the housing and having a pair of inner sides facing each other and a pair of outer sides facing away from each other; and
a pair of temperature detectors each detecting a temperature of one of the pair of terminals, the pair of temperature detectors each include:
a heat conducting member including a cylindrical portion and a connecting tab connected to the cylindrical portion, the connecting tab has a through hole receiving a bolt that fastens the heat conducting member to the outer side of one of the pair of terminals to create thermal contact between the heat conducting member and the one of the pair of terminals; and
a temperature sensor inserted into the cylindrical portion of the heat conducting member, the temperature sensor is in thermal contact with an inner peripheral wall of the cylindrical portion of the heat conducting member or is thermally connected to the inner peripheral wall of the cylindrical portion of the heat conducting member by a thermally conductive adhesive.

7. The connector according to claim 6, further comprising a pair of fastening assemblies respectively fastening a pair of cable connecting plates to the inner sides of the pair of terminals.

8. The connector according to claim 7, wherein the fastening assemblies respectively fasten the connecting tabs of the temperature detectors to the outer sides of the pair of terminals.

9. The connector according to claim 8, wherein the pair of temperature detectors are two of four temperature detectors of the connector and the pair of fastening assemblies are two of four fastening assemblies of the connector, the four fastening assemblies fasten the four temperature detectors with two of the four temperature detectors fastened on the outer side of each terminal.

10. The connector according to claim 8, further comprising a pair of cables and a pair of cable connecting plates electrically connected respectively to the pair of cables.

11. The connector according to claim 10, wherein the cable connecting plates are respectively fastened to the inner sides of the pair of terminals by the fastening assemblies.

12. The connector according to claim 11, wherein each of the fastening assemblies includes a nut and the bolt, the bolt passes through one of the cable connecting plates, one of the terminals, and the connecting tab of one of the pair of temperature detectors, the bolt is in threaded connection with the nut to fasten the one of the cable connecting plates and the connecting tab of one of the pair of temperature detectors to the one of the terminals.

13. The connector according to claim 12, wherein each of the fastening assemblies includes a rigid washer and an elastic washer, the bolt passes through the rigid washer and the elastic washer, the rigid washer and the elastic washer are disposed between the nut and the connecting tab of the one of the pair of temperature detectors to ensure a reliable thermal contact between the connecting tab of the one of the pair of temperature detectors and the one of the terminals to prevent loosening of the connecting tab of the one of the pair of temperature detectors.

14. The connector according to claim 13, wherein the rigid washer is compressed between the connecting tab of the one of the pair of temperature detectors and the elastic washer, the elastic washer is compressed between the rigid washer and the nut.

15. The connector according to claim 8, wherein each of the terminals includes:
a first terminal plate having a row of first elastic arms at a front end thereof and a first connecting plate at a rear end thereof; and
a second terminal plate stacked on an outer side of the first terminal plate and having a row of second elastic arms at a front end thereof and a second connecting plate at a rear end thereof.

16. The connector according to claim 15, wherein the row of second elastic arms abuts against an outer side of the row of first elastic arms, the first elastic arms and the second elastic arms are simultaneously in electrical contact with one side of a mating plug inserted between a pair of front ends of the pair of terminals, the second connecting plate abuts against an outer side of the first connecting plate, and the connecting tab of the heat conducting member abuts against an outer side of the second connecting plate to be in thermal contact with the outer side of the second connecting plate.

17. The connector according to claim 16, wherein a first contact is formed at a tail end of each of the first elastic arms, and a second contact is formed at a tail end of each of the second elastic arms, the first contacts and the second contacts being arranged in a row alternatively and simultaneously in electrical contact with one side of the mating plug inserted between the front ends of the pair of terminals.

18. The connector according to claim 16, wherein the terminal includes an auxiliary elastic piece stacked on an outer side of the second terminal plate and having a row of auxiliary elastic arms at a front end thereof and an auxiliary connecting plate at a rear end thereof.

19. The connector according to claim 18, wherein the auxiliary connecting piece abuts against the outer side of the second connecting plate, and the first terminal plate, the second terminal plate and the auxiliary elastic piece are riveted together by a riveting pin passing therethrough.

20. A connector assembly, comprising:
a connector including:
a housing;
a pair of terminals inserted in the housing and having a pair of inner sides facing each other and a pair of outer sides facing away from each other; and
a pair of temperature detectors each detecting a temperature of one of the pair of terminals, the pair of temperature detectors each include:
a heat conducting member including a cylindrical portion and a connecting tab connected to the cylindrical portion, the connecting tab has a through hole receiving a bolt that fastens the heat conducting member to the outer side of one of the pair of terminals to create thermal contact between the heat conducting member and the one of the pair of terminals; and
a temperature sensor inserted into the cylindrical portion of the heat conducting member, the temperature sensor is in thermal contact with an inner peripheral wall of the cylindrical portion of the heat conducting member or is thermally connected to the inner peripheral wall of the cylindrical portion of the heat conducting member by a thermally conductive adhesive; and
a mating connector mating with the connector, the mating connector includes a mating plug inserted between the pair of terminals of the connector and in electrical contact with the pair of terminals.
